(19) United States
(12) Patent Application Publication
(10) Pub. No.: US 2007/0001150 A1
(43) Pub. Date: Jan. 4, 2007

(54) Corrosion-inhibiting composition and method of use

(76) Inventors: Roy D. Hudgens, Cookeville, TN (US); David L. Brisk, Aurora, CO (US); David O. Trahan, Lafayette, LA (US); Joeseph M. Neathamer JR., Gretna, LA (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/170,212

(22) Filed: Jun. 29, 2005

(51) Int. Cl. C09K 3/00

(52) U.S. Cl. 252/390

(57) ABSTRACT

This invention relates in one aspect to a composition for inhibiting corrosion, such as flash rust, on metal surfaces. The composition described can include an organic acid component or a salt thereof, an azole component, an imidazoline component, a basic amine component, a phosphonate component, and a carrier including water and an alcohol such as glycol. The composition can also include surfactants, defoamers, buffers and other components as well. In another aspect, the invention relates to a method for treating metal surfaces to inhibit corrosion, comprising the steps of mixing, diluting and contacting or otherwise applying the above composition to the metal surface by spraying, dipping, coating or other effective means.

### BACKGROUND OF THE INVENTION

The present invention is directed to a corrosion-inhibiting composition and to a method of protecting metallic surfaces from corrosion using the same.

It is known that metal surfaces can undergo very rapid corrosion, sometimes within minutes or hours depending upon the conditions and the metal composition. This can typically occur when the metal surfaces are in contact with aqueous solutions, particularly acidic solutions, with highly ionic solutions, and even with hard water. This rapid corrosion phenomenon is commonly referred to as “flash rust” in the case of ferrous metal surfaces, but is equally a problem with non-ferrous metal surfaces as well. It should also be noted that not all such rapid corrosion (or flash rust) is readily visible, yet the presence of any such corrosion can be harmful and can be generally detected upon more in-depth analysis. Flash or rust corrosion can be particularly problematic in the manufacture of a variety of metallic components for various uses that come in contact with aqueous solutions during fabrication, assembly or subsequent testing or use.

For example, engine manufacturers frequently test the assembled engines prior to shipping or installing the engines into vehicles or at their location of operation. After assembly and prior to shipping or storage, for example, the “free engines” may be run through a variety of tests including dynamometer testing which requires a running engine. To do so, coolant is circulated through the engine's coolant system while the engine runs in a stationary position. After the test, the coolant is drained for use in subsequent tests on other engines. However, residual coolant or other moisture remains in the engine's coolant system and on its associated components. This residual coolant and ambient moisture along with oxygen in air can lead quickly to flash rust of various cast iron and steel engine components. Obviously, the manufacturer would like to prevent the occurrence of this flash rust if possible.

Previous solutions for attempting to prevent flash rust in these situations include use of a soluble oil or an oil-in-water emulsion to circulate through the engine's coolant system after such testing is completed. The soluble oil is thought to leave an oily film covering the metallic components that may provide protection against such corrosion. However, when the engines are later installed or put into operation, the oily residue on the metal surfaces can cause fouling of the associated cooling system or other components. The oily sludge that can thereby be produced and later accumulate can even promote corrosion of its own, and can also reduce heat transfer capabilities of the engine system as a whole.

In light of the above discussion and problems being encountered, there is a continuing need for advancements in the relevant fields, including improved coating and coolant compositions and methods for treating these and other metallic components to prevent flash rust or corrosion and also to deal with it if it occurs. The present invention is addressed to these needs.

### SUMMARY OF THE INVENTION

In various aspects, the present invention relates to a corrosion-inhibiting composition and method for use of the same as a coolant additive or a coating to inhibit corrosion both in and on metal surfaces. While the actual nature of the invention covered herein can only be determined with reference to the claims appended hereto, certain forms and features, which are characteristic of the preferred embodiments disclosed herein, are described briefly as follows.

In one form, the present invention provides a preferred corrosion-inhibiting composition that comprises: an organic acid component including at least one dicarboxylic acid or a salt thereof having between about 10 and 12 carbon atoms, the acid component being included in an amount up to about 15 weight percent (wt %) of the total composition; an azole component included in an amount up to about 5 wt %; an imidazoline component included in an amount up to about 15 wt %; a basic amine component including an alkylamine or an alkanolamine or a mixture or salt thereof; a phosphonate component included in an amount up to about 5 wt %; and an alcohol component. Preferably, the composition is formulated to exhibit a pH of between about 7 and about 10. Preferably also, the composition is aqueous-based and includes a water component in some amount and is effective to inhibit corrosion on ferrous and non-ferrous metal surfaces.

In another form, the present invention provides a preferred method of inhibiting rust formation on a metal surface. The preferred method comprises the step of contacting or otherwise treating a metal surface in some manner with a corrosion-inhibiting composition that comprises: an organic acid component including at least one dicarboxylic acid or a salt thereof having between about 10 and 12 carbon atoms; an azole component; an imidazoline component; at least an effective amount of a basic amine component to neutralize the organic acid component; and a polyphosphonate component. The preferred treating step is with a composition formulated to exhibit a pH of between about 7 and about 10 and that is aqueous-based and includes a water component in some amount.

In various embodiments, the preferred method comprises mixing and then applying the corrosion-inhibiting composition to the metal surface by way of flushing the composition through an otherwise closed fluid system, by dipping or immersing the metal part in a heated or unheated bath containing the composition, or by spraying or otherwise painting the composition on the metal part using a technique appropriate under the circumstances. In yet other embodiments, the preferred composition is as described above and hereinafter and the preferred method may further include storing, transporting or using the treated metal part or drying the treated part to form a coating of the composition that is dry to the touch and protects against corrosion thereafter.

### DETAILED DESCRIPTION OF THE INVENTION

For the purposes of promoting an understanding of the invention, certain preferred compositions and treatment methods will be discussed below. It will nevertheless be understood that no limitation of the scope of the invention is thereby intended. Any alterations and further modifications in the described compositions, their ingredients and treatment methods, and any further applications of the principles of the invention as described herein, are contemplated as would normally occur to one skilled in the art to which the invention relates.

With that in mind, the present invention provides as one preferred embodiment a composition suitable for use as a corrosion inhibitor for metal surfaces. The preferred composition finds particular advantageous use on ferrous metal surfaces such as steel and cast iron, although many non-ferrous metal surfaces can derive protection and thereby benefit from the preferred composition described herein as well. The preferred composition also finds particular benefit as a coolant composition for use with engine design and manufacture. In any event, this preferred embodiment according to the present invention includes broadly an organic acid component or a salt thereof, an azole component, an imidazoline component, a basic component (preferably an amine base or a salt thereof), a phosphonate component, and a carrier preferably aqueous-based including an alcohol and water. The corrosion-inhibiting composition according to this embodiment is also preferably formulated to have a pH of between about 7 and about 10.

For use in this preferred embodiment of the present invention, the organic acid component includes at least one dicarboxylic acid which contributes to the corrosion-inhibiting properties of the composition. Preferably, the dicarboxylic acid is selected to have between about 10 and 12 carbon atoms. Particularly preferred dicarboxylic acids within this range include linear or branched aliphatic dicarboxylic acids. Non-limiting examples of suitable acids for this purpose include sebacic acid, decanedioic acid, undecanedioic acid, dodecanedioic acid, 2-dodecenedioic acid, 3-tert-butyladipic acid, 1,1-cyclohexanediacetic acid, and mixtures and/or salts of these same acids. In certain embodiments of the composition, a mixture of two, three or more dicarboxylic acids can be successfully employed. One commercially available example of such a mixture of dicarboxylic acids suitable for use in the present invention is sold under the trademark Corefree M-1 by Dupont.

Preferably also, the corrosion-inhibiting composition according to this embodiment includes up to about 15 wt % of this acid component based upon the total weight of the composition. More preferably, the composition includes between about 0.08 and about 3.2 wt % of the acid component based upon the total weight of the composition; and even more preferably, it includes between about 0.4 and about 2.8 wt %. Unless specified herein to the contrary, all weight percentages (wt %) are listed as weight percentages based upon the total weight of the corrosion-inhibiting composition being considered or used.

This preferred corrosion-inhibiting composition of the present invention also preferably includes an azole component. Non-limiting examples of suitable azoles for use in the present invention include benzotriazole, tolyltriazole and mercaptobenzothiazole. The azole component can be included in varying amounts sufficient to be effective in also contributing to the corrosion-inhibiting properties of the overall composition. Moreover, the azole component can be particularly beneficial in connection with non-ferrous metal surfaces including copper, brass and aluminum. Preferably, the azole is included in an amount up to about 5 wt % of the total weight of the composition. More preferably, it is included in an amount between about 0.08 and about 1.5 wt %, and even more preferably, between about 0.4 and about 1.0 wt %.

This preferred corrosion-inhibiting composition of the present invention also preferably includes an imidazoline component. Preferred imidazoline components can be effective in contributing as co-inhibitors of corrosion, either alone or in combination with other components of the composition. Preferably, the imidazoline component includes an ethoxylated imidazoline. One commercially available example of such an ethoxylated imidazoline suitable for use in the present invention is sold under the trademark Aquaness Aminox 158 by Baker Inteq of Sugarland, Tex. In any case, the imidazoline component is preferably included in the composition in an amount up to about 15 wt %. More preferably, it is present between about 0.08 and about 3.2 wt %, and even more preferably, between about 0.4 and about 2.0 wt %. As such, for example, the preferred ethoxylated imidazoline provides a water soluble, oil dispersible component that aids in the protection particularly of ferrous metals exposed to corrosive water environments. Such selected imidazolines can even be effective at low addition levels even in hard water systems. The preferred imidazoline component can also provide a high degree of detergency, as well as rapid film-forming characteristics on a variety of metal surfaces.

This preferred composition of the present invention also includes a basic component. Preferably, the basic component is an amine such as an alkylamine or an alkanolamine, and can be selected as a primary, secondary or tertiary amine compound or a salt thereof. The basic component can also be added to provide a salt, such as either a mono- or a di-salt, of the acid component described above. In preferred embodiments from testing thus far, a sufficient amount of the basic component is provided to at least neutralize the acidic component and provide a corrosion-inhibiting composition with a pH between about 7 and about 10. It is understood in this regard that the pH level of the corrosion-inhibiting composition can also be maintained within such a select pH range or can be further modified as conditions may require using one or more buffering agents as are discussed below. Non-limiting examples of suitable amine compounds that can be included in the basic component of this preferred embodiment include one or more of the following: ethylamine; diethylamine; triethylamine; cyclohexylamine; dicyclohexylamine; diethylethanolamine; monoethanolamine; diethanolamine; triethanolamine; aminoethylpiperazine; morpholine; methyldiethanolamine; and aminoethylethanolamine.

The preferred composition of the present invention also includes a phosphonate component. Preferred phosphonates have been found and shown to aid in providing superior film-forming characteristics on the metal surfaces the composition is used to treat. In certain embodiments, the phosphonate can be an organophosphonate or a polyaminophosphonate. Examples of suitable phosphonates for use in the present invention include two commercially available polyphosphonic polymers sold under the trademarks Telomer C-Six by Telomer Corporation and Versenex CSI by Dow. Such preferred phosphonate compounds have been found to be particularly effective in the composition when in the presence of low levels of chlorine of less than about 5 parts per million (“ppm”), and can offer copper alloy protection as an additional benefit. The preferred corrosion-inhibiting composition of the present invention includes this phosphonate component in an amount up to about 5 wt %. More preferably, it is present between about 0.08 and about 3.2 wt %, and even more preferably, in an amount between about 0.08 and about 0.8 wt %.

The corrosion-inhibiting composition according to this preferred embodiment of the present invention also includes a carrier of some kind and amount. The preferred carrier is aqueous-based and can include water and/or an alcohol component. The preferred alcohol component can comprise a monohydric, dihydric, trihydric or other polyhydric alcohol. Depending on the particular metal part or surface to be treated and the concentration of the overall composition used, varying amounts of the alcohol and water components can be formulated in the composition. For example, in a concentrated form, the preferred composition can include less than about 80 wt % water overall. In use, this concentrated composition can be diluted up to about a twenty-fold dilution, i.e., about 1:20 (concentrate:water), or even more depending on the application. A ready-to-use formulation of the preferred composition can include between about 60 and about 90 wt % water depending on the application.

The preferred alcohol component can also be added in varying amounts, depending on the metal part or surface treated and whether a concentrate or a ready-to-use formulation is desired. For example, a concentrated formulation can include between about 1 and about 10 wt % of the alcohol component. This concentrate can be diluted at between about a five (5) and about a ten (10) dilution ratio or more for the ready-to-use formulation. Preferred examples of alcohols for use in this embodiment of the present invention include dihydric alcohols, i.e., glycols or diols and trihydric alcohols. Non-limiting examples of such preferred dihydric and trihydric alcohols include ethylene glycol, propylene glycol and other glycols including diethylene, triethlyene and the like.

While above references are made for purposes of clarity and convenience to both a concentrated formulation and a ready-to-use formulation of the preferred corrosion-inhibiting composition, it will be understood that these formulations are proscribed for and by the end user in all cases. If desired, for example, the concentrated formulation can be used “as is” depending upon the particular application, environment, method of treatment and types of metal surfaces in need of protection.

In select embodiments, the preferred corrosion-inhibiting composition of the present invention as described herein can also include other components as well, such as surfactants, buffers, emulsifiers, sequestering agents and defoamers to name a few. Non-limiting examples of such preferred defoamers, for example, include polyglycol and silicon defoamers. Commercially available polyglycol defoamers suitable for use in the present invention include, for example, two products sold under the respective trademarks Pluronic by BASF and Q2-3183A by Dow Corning. Non-limiting examples of suitable silicon defoamers also available include the following: dimethylpolysiloxane hydrolyzate; alpha-methyl-omega-methoxypolydimethylsiloxane; polydimethyl silicone oil; poly(dimethylsiloxane); polydimethylsiloxane, methyl end-blocked; polyoxy(dimethylsilylene), alpha-(trimethylsilyl)-omega-hydroxy; poly[oxy(dimethylsilylene)], alpha-[trimethylsilyl]-omega-[(trimethylsilyl)oxy]; silicone oils; alpha-(trimethylsilyl)poly[oxy(dimethylsilylene)]-omega-methyl; and mixtures thereof. The preferred composition can include such defoamers in varying numbers and amounts sufficient to inhibit foaming during use in treating a metal surface, whether that is in a bath, spray or other method of application. Such defoamers can also be particularly beneficial during addition of the various other components in the composition such as the basic component, the imidazoline component, and the azole component. In selected preferred embodiments, such defoamers can be present in an amount between about 0.01 and about 0.1 wt % of the composition suitable to accomplish the beneficial effect intended.

The preferred composition of the present invention can also include one or more buffers. Preferably, the composition includes such a buffering component to help maintain the composition at a pH between about 7 and about 10 as described above. In addition, the preferred buffers can include inorganic bases such as sodium hydroxide and potassium hydroxide, as well as known or commonly used buffering agents such as phosphates and borates. Such selected buffering agents can also exhibit both beneficial anti-corrosion and buffering properties of their own. For example, certain benzoate salts, borate salts and phosphate salts can provide both buffering and anti-corrosion advantages to the overall composition. In select embodiments, the preferred composition can also be formulated to be phosphate free in that it does not contain a phosphate salt, either as a buffering agent or as a corrosion-inhibiting component. As for preferred choices of such buffering components, while it may not be critical for all facets of the present invention, buffering agents can be selected to comply with the desires of the particular end users and applications, whether for compliance with regulatory requirements for certain regions of the country or to be compatible in certain environments or on certain metal surfaces to be treated.

Surfactants may also be used in this preferred embodiment of the invention, and can include a variety of known surfactant compounds. Non-limiting examples include, either alone or in combination: alkyl sulfonate; acryl sulfonate; phosphate esters; sulfosuccinate; acetylenic glycol; and ethoxylated alcohols. One commercially available example of such a surfactant suitable for use in the present invention is sold under the trademark NF-12 by the Stepan Company. When included, such surfactants can be preferably provided in an amount up to about 1 wt %, and more preferably, range between about 0.1 and about 1 wt %. When used in this way, such surfactants can add to and provide good wetting ability to enhance the wetting of the metal surface with and for the other ingredients of the overall composition.

This preferred corrosion-inhibiting composition and method of the present invention can also preferably be blended to provide a uniform composition for treating the metal surfaces, either as a concentrate or a ready-to-use formulation as discussed above. The order of addition or mixing of the individual components is not particularly critical for the overall practice and beneficial effects of the invention. However, as already stated, when desired to be used, the defoamer may be added concurrent with or prior to the addition of various of the components such as the imidazoline, the azole and the basic amine in order to take advantage of its additional beneficial effects.

The preferred composition according to the present invention can also be provided as a concentrated formulation as, for example, in preparing it to be shipped to potential end users.

The concentrated formulation can include a lesser amount of the liquid carrier in such cases, such as the alcohol or the water components, which may also benefit its shipment as well.

The concentrated composition, once received, can then be diluted either with water or alcohol or both such that the preferred water component is present in an amount between about 60 and about 90 wt % as described above. In addition, or in the alternative, the alcohol component can also be adjusted such that it is included in an amount between about 1 and about 10 wt % as discussed above as well.

Once formulated and provided to an end user, the preferred composition of the present invention can be used as discussed above to provide corrosion-inhibiting properties and protection for metal surfaces. In one preferred method of application, the composition can be provided and used as an engine coolant by possibly varying the types and amounts of the alcohol and water components to achieve a coolant fluid formulation exhibiting a suitable operating temperature range, i.e., a suitable boiling point elevation and freezing point depression for the operating conditions to be encountered. This preferred coolant formulation can then be used in its normal ways on “free engines” during initial dynamometer testing or during initial break-in periods or with a rebuilt engine if needed, and also prior to shipping or storage. In such uses, the composition can be circulated through the engine's coolant system during the testing or break-in or rebuild period. Upon completion of this use, the composition can be drained from the engine coolant system and stored for later use. While it is preferable to remove essentially all or at least a majority of the composition from the engine, this is not critical to achieving the beneficial affects of the preferred embodiments discussed herein. For example, the preferred composition leaves a protective film on the contacted metal surfaces that has been found to sufficiently and effectively inhibit flash rust or corrosion, whether the composition is completely drained after use or not. If the contacted surfaces of the engine are allowed to dry, it has also been found that this protective film coating will be generally dry to the touch. Otherwise, if the contacted surfaces remain wet with the composition, it has been found that the protective film remains present and effective as well. In that case, it has also been found that any remaining composition in the system does not later result in any accumulated sludge or other fouling of the engine or its component parts during subsequent use.

In still other embodiments, the preferred composition and method according to the present invention can be applied to various ferrous and non-ferrous metal surfaces whether or not they are associated in any way with internal combustion engines or engine parts. Such application processes can include by spraying, dipping, painting, or otherwise coating or contacting any of such metal surfaces as may be desired to be protected in whole or in part. Such contacting can also include through the vapor phase application of the composition to such metal surfaces as well, as may be appropriate under the circumstances.

For the purpose of promoting a further understanding and appreciation of the present invention and its various embodiments and advantages, the following specific Example is being provided. It will be understood, however, that this Example is illustrative only and not limiting in any way or fashion as to the scope of the present invention as a whole.

### EXAMPLE

A representative formulation of a preferred corrosion-inhibiting composition according to and for use in the present invention was prepared in concentrated form by combining appropriate amounts of the respective components to arrive at weight percentages according to the listing in Table 1. For additional information relating to available forms of these and other individual components suitable for use in the preferred composition and method of the present invention, as well as for commercially available and other mixtures thereof, reference can be made to U.S. Provisional Application No. 60/640,002 to David O. Trahan and Joe Neathamer filed Dec. 29, 2004, which is hereby incorporated by reference in its entirety.

TABLE 1
Corrosion-Inhibiting Formulation

| Individual Components | Approx. Wt % of Total Composition |
|---|---|
| Corfree M-1 | 1.4 wt % |
| Tolytriazole (50%) | 0.8 wt % |
| Aminox 158 | 2.4 wt % |
| Triethanolamine (TEA) | 3.0 wt % |
| Versenex CSI | 0.5 wt % |
| Propylene Glycol | 4.0 wt % |
| Sodium Hydroxide (Base/50%) | 0.12 wt % |
| NF-12 (Surfactant) | 0.8 wt % |
| Pluronic L-61 (Defoamer) | 0.008 wt % |
| Q2-3183A (Defoamer) | 0.056 wt % |
| Silicone Oil (Defoamer) | 0.004 wt % |
| Water | 86.912 wt % |

Once formulated, a testing procedure was established to compare the effectiveness of various concentrations of the above corrosion-inhibiting composition on three different metal surfaces and under two different environments. As to the procedure followed, sections of the metal bodies were immersed in the specific solutions for about two hours at about 190° F. The metal sections were then placed in a humidity-controlled cabinet for a one-week period of time and at a temperature of about 95° F. and about 95% relative humidity. After one week, the metal samples were removed from the cabinet and then visually inspected and evaluated as to the amount of rust or other corrosion covering the surfaces of the metal parts. In two of the tests, samples of untreated metal bodies were also subjected to the humidity cabinet and inspected without having had any application of the corrosion-inhibiting composition.

As to the specific concentrations tested, the immersion testing was performed using concentrations of the above formulation ranging from levels of about 3.0%, 5.0%, 7.0% and 10.0%, all determined by and based on the total volume of solution used in the immersion bath. To assist with the subsequent visual evaluation, the following rating scale or system was also established with the understanding that Ratings of 4 and 5 are clearly acceptable and even a Rating of 3 can be acceptable under certain circumstances:
Rating 1—Heavy Rust Over Entire Metal Surface
Rating 2—Moderate Rust Over about 70 to 80% of Metal Surface
Rating 3—Areas of Light Rust Over about 20 to 30% of Metal Surface
Rating 4—Small Spots of Rust Covering Less Than about 5% of Metal Surface
Rating 5—No Rust Exhibited on Metal Surface With this methodology, the first series of metal bodies tested were cast iron pump bodies, such as are commonly used in engine manufacture, which were subjected to a solution bath containing varying concentrations of the above formulation along with 300 ppm of hard water. After the above procedure and evaluation was completed, the following results were observed for the respective concentrations used:
No Corrosion-inhibiting Treatment—Rating 1
3.0% Concentration by Volume—Rating 2
5.0% Concentration by Volume—Rating 3
7.0% Concentration by Volume—Rating 4
10.0% Concentration by Volume—Rating 4

With this same methodology, the second series of bodies tested were also cast iron metal parts which were this time subjected to a deionized water solution containing the respective concentrations of the corrosion-inhibiting composition. After completion, the following results were observed:
3.0% Concentration by Volume—Rating 4
5.0% Concentration by Volume—Rating 4
7.0% Concentration by Volume—Rating 4
10.0% Concentration by Volume—Rating 4

Again with this same methodology, the third series of metal bodies tested were steel panels such as are used in many areas of manufacture. The steel panels were also subjected to a deionized water bath containing varying amounts of the formulation above. Once again, after completion the following results were observed:
No Corrosion-inhibiting Treatment—Rating 2
5.0% Concentration by Volume—Rating 4
10.0% Concentration by Volume—Rating 5

Overall, the results of this Example and testing procedure showed that varying concentrations of the preferred corrosion-inhibiting composition and method according to the present invention proved effective in reducing or eliminating flash rust and other surface corrosion from the metal parts tested after exposure to these differing environments. Moreover, as discussed above, this Example showed that the concentrated composition can be diluted up to a ratio of about 1:20 gallons (concentrate:water) or more and still provide an effective ready-to-use formulation to treat metal surfaces exposed to corrosive aqueous fluids. In some hard water or acidic conditions having a pH less than 7, it may be preferable to dilute the concentrate at a ratio of about 1:10 (concentrate:water) or more for some uses.

The above corrosion-inhibiting composition as formulated and tested in the Example was also substantially oil free. In other embodiments, the preferred composition can also be formulated free of nitrites, phosphates or silicates as well if the conditions or circumstances require. Preferably, as above, the composition includes no soluble oil-type additives. Therefore, no oily residues can possibly remain on the coated surface of the metal components after treatment. In select embodiments, the above preferred composition can also be formulated as a coolant composition and used specifically to protect engines from flash rust and corrosion during normal engine break-in or dynamometer testing and when placing the engines in storage or shipping them dry. In other embodiments, the above composition can be formulated as an aqueous-based corrosion-inhibiting composition suitable for treating a variety of other ferrous and non-ferrous metal surfaces.

Thus formulated, the above preferred composition of the present invention provides superior corrosion-inhibiting properties and is suitable for use as a corrosion-inhibitor for a variety of metal surfaces. These include ferrous metals including steel and cast iron, as well as non-ferrous metal surfaces including aluminum, copper and brass. The above composition has also been found to be effective in inhibiting flash rust and corrosion in situations particularly detrimental to such metal surfaces, as when exposed to high temperatures, hard water, concentrated salts, and various chlorine containing environments.

In addition to those embodiments and variations thereof which are discussed above, the present invention contemplates such other modifications as would occur to those ordinarily skilled in this art. It is also contemplated, for example, that compositions embodying the present invention can be altered or added to other compositions as would also occur to those ordinarily skilled in the art without departing from the scope or spirit of the present invention.

While the invention has also been thus disclosed and described in detail in the foregoing description, the same is intended and considered to be illustrative and not restrictive in character, it being understood that only the preferred embodiments have been disclosed and described and that all changes and modifications that come within the spirit of the invention are desired to be protected. Still further, any theory of operation, proof or finding stated herein is only meant to further enhance the understanding of the present invention and is not intended to make the scope of the present invention dependent upon or limited in any way to the same.

What is claimed is:

1. A corrosion-inhibiting composition, comprising:
an organic acid component including at least one dicarboxylic acid or a salt thereof having between about 10 and 12 carbon atoms, said acid component included in an amount up to about 15 wt %;
an azole component included in an amount up to about 5 wt %;
an imidazoline component included in an amount up to about 15 wt %;
a basic amine component including an alkylamine or an alkanolamine or a mixture or salt thereof;
a phosphonate component included in an amount up to about 5 wt %; and
an alcohol component;
said composition having a pH of between about 7 and about 10 and being effective to inhibit corrosion on metal surfaces.

2. The composition of claim 1 wherein said organic acid component comprises a combination of decanedioic acid and dodecanedioic acid.

3. The composition of claim 1 wherein said organic acid component includes an aliphatic dicarboxylic acid.

4. The composition of claim 1 comprising between about 0.08 and about 3.2 wt % of said organic acid component.

5. The composition of claim 4 comprising between about 0.4 and about 2.8 wt % of said organic acid component.

6. The composition of claim 1 comprising between about 0.4 and about 1.5 wt % of said azole component.

7. The composition of claim 6 comprising between about 0.4 and about 1.0 wt % of said azole component.

8. The composition of claim 1 wherein said azole component includes tolyltriazole, mercaptobenzotriazole or benzotriazole or a mixture thereof.

9. The composition of claim 1 wherein said basic amine component is added in an effective amount to at least neutralize said organic acid component in the composition.

10. The composition of claim 1 comprising between about 0.08 and about 3.2 wt % of said basic amine component.

11. The composition of claim 1 wherein said basic amine component includes ethylamine; diethylamine; triethylamine; cyclohexylamine; dicyclohexylamine; diethylethanolamine; monoethanolamine, diethanolamine, triethanolamine, aminoethylpiperazine, morpholine, methyl diethanolamine or aminoethylethanolamine or a mixture thereof.

12. The composition of claim 1 wherein said phosphonate component includes an organophosphonate or a polyaminophosphonate.

13. The composition of claim 1 comprising between about 0.08 and about 3.2 wt % of said phosphonate component.

14. The composition of claim 13 comprising between about 0.08 and about 0.8 wt % of said phosphonate component.

15. The composition of claim 1 wherein said imidazoline component includes an ethoxylated imidazoline.

16. The composition of claim 1 comprising between about 0.8 and about 3.2 wt % of said imidazoline component.

17. The composition of claim 16 comprising between about 0.4 and about 2.0 wt % of said imidazoline component.

18. The composition of claim 1 also comprising an effective amount of a polyglycol defoamer or a silicone defoamer added to the composition.

19. The composition of claim 18 wherein the silicone defoamer includes dimethylpolysiloxane hydrolyzate; alpha-methyl-omega methoxypolydimethylsiloxane; polydimethyl silicone oil; poly(dimethylsiloxane); polydimethylsiloxane, methyl end-blocked; polyoxy(dimethylsilylene), alpha-(trimethylsilyl)-omega-hydroxy; poly[oxy(dimethylsilylene)], alpha-[trimethylsilyl]-omega-[(trimethylsilyl)oxy]; silicone oils; or alpha-(trimethylsilyl)poly[oxy(dimethylsilylene)]-omega-methyl; or a mixture thereof.

20. The composition of claim 1 and further being substantially free of hydrocarbon-based oils.

21. The composition of claim 1 wherein said alcohol component includes a glycol.

22. The composition of claim 21 wherein said alcohol component includes ethylene glycol, propylene glycol, diethlyene glycol or tri-ethlyene glycol or a mixture thereof.

23. The composition of claim 1 provided as a concentrated formulation.

24. The composition of claim 1 provided as a ready-to-use formulation diluted with water or an alcohol.

25. The composition of claim 1 and further comprising an effective amount of one or more of a defoamer, a surfactant and an emulsifier component added in the composition.

26. The composition of claim 1 and further comprising an effective amount of a buffer component added in the composition.

27. A corrosion-inhibiting composition, comprising:
an organic acid component including at least one dicarboxylic acid or a salt thereof having between 10 and 12 carbon atoms, said acid component included in an amount between about 0.08 and about 3.2 wt %;
an azole component included in an amount between about 0.4 and about 1.5 wt %;
an imidazoline component included in an amount between about 0.8 and about 3.2 wt %;
a basic amine component including an alkylamine or an alkanolamine or a mixture or salt thereof;
a phosphonate component included in an amount between about 0.08 and about 3.2 wt %; and
an alcohol component;
said composition having a pH of between about 7 and about 10 and being effective to inhibit corrosion on metal surfaces.

28. A method for inhibiting corrosion on a metal surface, comprising the step of contacting the metal surface with a composition comprising:
an organic acid component including at least one dicarboxylic acid or a salt thereof having between 10 and 12 carbon atoms;
an azole component;
an imidazoline component;
at least an effective amount of a basic amine component to neutralize the organic acid component; and
a phosphonate component, the composition being formulated to exhibit a pH of between about 7 and about 10 during said contacting.

29. The method of claim 28 wherein said contacting comprises one or more of spraying, dipping or coating the metal surface with the composition.

30. A method for inhibiting corrosion on a metal surface, comprising the steps of mixing a composition comprising:
an organic acid component including at least one dicarboxylic acid or a salt thereof having between about 10 and 12 carbon atoms, said acid component included in an amount up to about 15 wt %;
an azole component included in an amount up to about 5 wt %;
an imidazoline component included in an amount up to about 15 wt %;
a basic amine component including an alkylamine or an alkanolamine or a mixture or salt thereof;
a phosphonate component included in an amount up to about 5 wt %; and
an alcohol component;
and applying an effective amount of the mixed composition to a metal surface to inhibit corrosion thereon, said applying being with the composition exhibiting a pH of between about 7 and about 10.

31. The method of claim 30 and additionally comprising the step of diluting the composition during or after said mixing to the desired concentration for said applying.

32. The method of claim 31 wherein said applying comprises one or more of spraying, dipping or coating the metal surface with said mixed and diluted composition.

33. The method of claim 32 and further comprising the step of removing the excess composition from the metal surface after said applying.

34. The method of claim 33 and further comprising the step of drying the metal surface after said applying and removing.
